(19) United States
(12) Patent Application Publication
(10) Pub. No.: US 2016/0365084 A1
(43) Pub. Date: Dec. 15, 2016

(54) HYBRID FINITE IMPULSE RESPONSE FILTER

(71) Applicant: Cirrus Logic International Semiconductor Ltd., Edinburgh (GB)

(72) Inventors: Jeffrey D. Alderson, Austin, TX (US); John L. Melanson, Austin, TX (US); Nitin Kwatra, Austin, TX (US); Ryan A. Hellman, Austin, TX (US)

(21) Appl. No.: 14/734,418

(22) Filed: Jun. 9, 2015

(51) Int. Cl. G10K 11/178

(52) U.S. Cl. CPC G10K 11/1788; G10K 2210/3028; G10K 2210/3014; G10K 2210/3051; G10K 2210/509; G10K 2210/3012

(57) ABSTRACT

In accordance with embodiments of the present disclosure, a hybrid finite impulse response filter having a plurality of delay stages comprising a first filter portion and a second filter portion. In some embodiments, the first filter portion may be a high-rate filter portion associated with a first portion of the plurality of delay stages and configured to filter an input signal having a first sampling rate to generate a first intermediate output signal and the second portion may be a low-rate filter portion associated with a second portion of the plurality of delay stages and configured to filter a downsampled version of the input signal at a second sampling rate to generate a second intermediate output signal. In other embodiments, the first filter portion may include an analog filter portion associated with a first portion of the plurality of delay stages and configured to filter an input signal to generate a first intermediate output signal and the second filter portion may be a digital filter portion associated with a second portion of the plurality of delay stages and configured to filter the input signal.

### FIELD OF DISCLOSURE

The present disclosure relates in general to a hybrid finite impulse response (FIR) filter which may consume lower power and have lower delay than traditional FIRs, and systems such as adaptive noise cancellation systems, which may use such hybrid FIR.

### BACKGROUND

Wireless telephones, such as mobile/cellular telephones, cordless telephones, and other consumer audio devices, such as mp3 players, are in widespread use. Performance of such devices with respect to intelligibility can be improved by providing noise cancelling using a microphone to measure ambient acoustic events and then using signal processing to insert an anti-noise signal into the output of the device to cancel the ambient acoustic events.

In an adaptive noise cancellation system, a microphone may generate an electronic microphone signal indicative of ambient acoustic events, and such microphone signal may be filtered by an adaptive filter (e.g., a FIR filter) to generate an anti-noise signal that is combined with other audio data output to a speaker. In such systems, it is often desirable that the path from the microphone to the speaker have as little latency as possible, as the anti-noise signal must be generated from the microphone signal fast enough to cancel the ambient noise as it arrives at a listener's ear. It is also often desirable that the adaptive filter consume as little power as possible, so as to extend the battery life of a mobile device in which an adaptive noise cancellation system may reside.

### SUMMARY

In accordance with the teachings of the present disclosure, certain disadvantages and problems associated with existing approaches to filtering signals may be reduced or eliminated.

In accordance with embodiments of the present disclosure, a hybrid finite impulse response filter having a plurality of delay stages may include a high-rate filter portion associated with a first portion of the plurality of delay stages, a decimator, a low-rate filter portion associated with a second portion of the plurality of delay stages, an interpolator, and a summer. The high-rate filter portion may be configured to filter an input signal having a first sampling rate to generate a first intermediate output signal. The decimator may be configured to downsample the input signal to a downsampled input signal having a second sampling rate smaller than the first sampling rate. The low-rate filter portion may be configured to filter the downsampled input signal. The interpolator may be configured to upsample the downsampled input signal as filtered by the low-rate filter portion to generate a second intermediate output signal having a sampling rate larger than the second sampling rate. The summer may be configured to sum the first intermediate output signal and the second intermediate output signal to generate an output signal of the hybrid impulse response filter.

In accordance with these and other embodiments of the present disclosure, a method may include filtering, with a high-rate filter portion of a hybrid finite impulse response filter having a plurality of delay stages, an input signal having a first sampling rate to generate a first intermediate output signal. The method may also include downsampling the input signal to a downsampled input signal having a second sampling rate smaller than the first sampling rate. The method may additionally include filtering with a low-rate filter portion the downsampled input signal. The method may further include upsampling the downsampled input signal as filtered by the low-rate filter portion to generate a second intermediate output signal having a sampling rate larger than the second sampling rate. The method may also include summing the first intermediate output signal and the second intermediate output signal to generate an output signal of the hybrid impulse response filter.

In accordance with these and other embodiments of the present disclosure, an integrated circuit for implementing at least a portion of a personal audio device may include an output for providing an output signal to a transducer including both a source audio signal for playback to a listener and an anti-noise signal for countering the effect of ambient audio sounds in an acoustic output of the transducer, a microphone input for receiving a microphone signal, and a processing circuit. The processing circuit may implement a hybrid filter that generates the anti-noise signal to reduce the presence of the ambient audio sounds at the acoustic output of the transducer based at least on the microphone signal. The hybrid filter may include a high-rate filter portion configured to filter an input signal having a first sampling rate to generate a first intermediate anti-noise signal, a low-rate filter portion configured to filter the input signal downsampled to a second sampling rate to generate a second intermediate anti-noise signal, and a summer to sum the intermediate anti-noise signal and the second intermediate anti-noise signal to generate the anti-noise signal.

In accordance with these and other embodiments of the present disclosure, a hybrid finite impulse response filter may have a plurality of delay stages and include an analog filter portion associated with a first portion of the plurality of delay stages and configured to filter an input signal to generate a first intermediate output signal, a digital filter portion associated with a second portion of the plurality of delay stages and configured to filter the input signal, and a summer for summing the first intermediate output signal and the second intermediate output signal to generate an output signal of the hybrid impulse response filter.

In accordance with these and other embodiments of the present disclosure, a method may include filtering, with an analog filter portion associated with a first portion of a plurality of delay stages of a hybrid finite impulse response filter, an input signal to generate a first intermediate output signal. The method may also include filtering, with a digital filter portion associated with a second portion of the plurality of delay stages, the input signal. The method may also include summing the first intermediate output signal and the second intermediate output signal to generate an output signal of the hybrid impulse response filter.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example wireless mobile telephone, in accordance with embodiments of the present disclosure;

FIG. 1B is an illustration of an example wireless mobile telephone with a headphone assembly coupled thereto, in accordance with embodiments of the present disclosure;

FIG. 2 is a block diagram of selected circuits within the wireless mobile telephone depicted in FIG. 1, in accordance with embodiments of the present disclosure;

FIG. 3 is a block diagram depicting selected signal processing circuits and functional blocks within an example adaptive noise cancelling (ANC) circuit of a coder-decoder (CODEC) integrated circuit of FIG. 2 which uses feedforward filtering to generate an anti-noise signal, in accordance with embodiments of the present disclosure;

FIG. 4 is a block diagram depicting selected functional blocks within an example hybrid finite impulse response filter, in accordance with embodiments of the present disclosure; and

FIG. 5 is a block diagram depicting selected functional blocks within another example hybrid finite impulse response filter, in accordance with embodiments of the present disclosure.

### DETAILED DESCRIPTION

The present disclosure encompasses noise cancelling techniques and circuits that can be implemented in a personal audio device, such as a wireless telephone. The personal audio device includes an ANC circuit that may measure the ambient acoustic environment and generate a signal that is injected in the speaker (or other transducer) output to cancel ambient acoustic events. A reference microphone may be provided to measure the ambient acoustic environment and an error microphone may be included for controlling the adaptation of the anti-noise signal to cancel the ambient audio sounds and for correcting for the electro-acoustic path from the output of the processing circuit through the transducer.

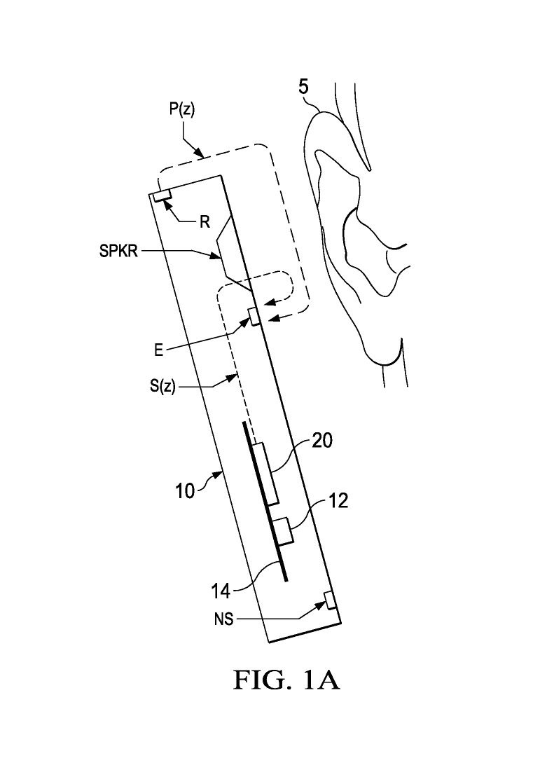

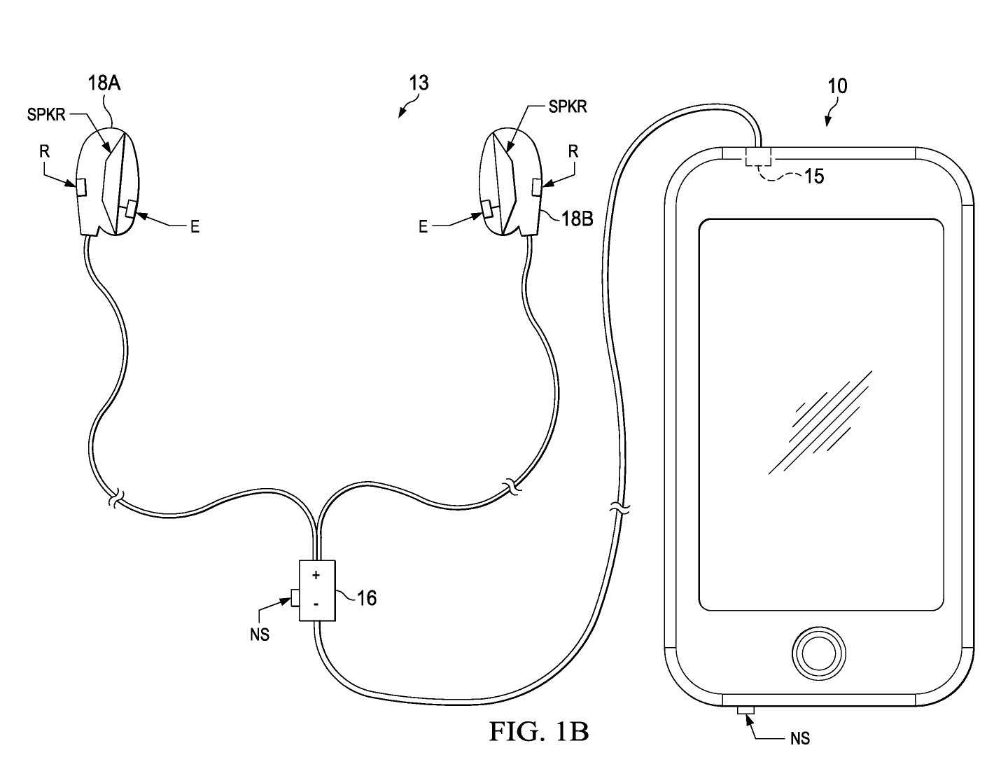

Referring now to FIG. 1A, a wireless telephone 10 as illustrated in accordance with embodiments of the present disclosure is shown in proximity to a human ear 5. Wireless telephone 10 is an example of a device in which techniques in accordance with embodiments of this disclosure may be employed, but it is understood that not all of the elements or configurations embodied in illustrated wireless telephone 10, or in the circuits depicted in subsequent illustrations, are required in order to practice the inventions recited in the claims. Wireless telephone 10 may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. A near-speech microphone NS may be provided to capture near-end speech, which is transmitted from wireless telephone 10 to the other conversation participant(s).

Wireless telephone 10 may include ANC circuits and features that inject an anti-noise signal into speaker SPKR to improve intelligibility of the distant speech and other audio reproduced by speaker SPKR. A reference microphone R may be provided for measuring the ambient acoustic environment and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when wireless telephone 10 is in close proximity to ear 5. In other embodiments, additional reference and/or error microphones may be employed. Circuit 14 within wireless telephone 10 may include an audio CODEC integrated circuit (IC) 20 that receives the signals from reference microphone R, near-speech microphone NS, and error microphone E and interfaces with other integrated circuits, such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of wireless telephone 10 adapt an anti-noise signal generated from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to wireless telephone 10, when wireless telephone 10 is not firmly pressed to ear 5. While the illustrated wireless telephone 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone.

Referring now to FIG. 1B, wireless telephone 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. In some embodiments, headphone assembly 13 may comprise a wireless headphone assembly, in which case all or some portions of CODEC IC 20 may be present in headphone assembly 13, and headphone assembly 13 may include a wireless communication interface (e.g., BLUETOOTH® interface) in order to communicate between headphone assembly 13 and wireless telephone 10.

As used in this disclosure, the term “headphone” broadly includes any loudspeaker and structure associated therewith that is intended to be mechanically held in place proximate to a listener's ear canal, and includes without limitation earphones, earbuds, and other similar devices. As more specific examples, “headphone” may refer to intra-concha earphones, supra-concha earphones, and supra-aural earphones.

Combox 16 or another portion of headphone assembly 13 may have a near-speech microphone NS to capture near-end speech in addition to or in lieu of near-speech microphone NS of wireless telephone 10. In addition, each headphone 18A, 18B may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. Each headphone 18A, 18B may include a reference microphone R for measuring the ambient acoustic environment and an error microphone E for measuring of the ambient audio combined with the audio reproduced by speaker SPKR close to a listener's ear when such headphone 18A, 18B is engaged with the listener's ear. In some embodiments, CODEC IC 20 may receive the signals from reference microphone R and error microphone E of each headphone and near-speech microphone NS and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

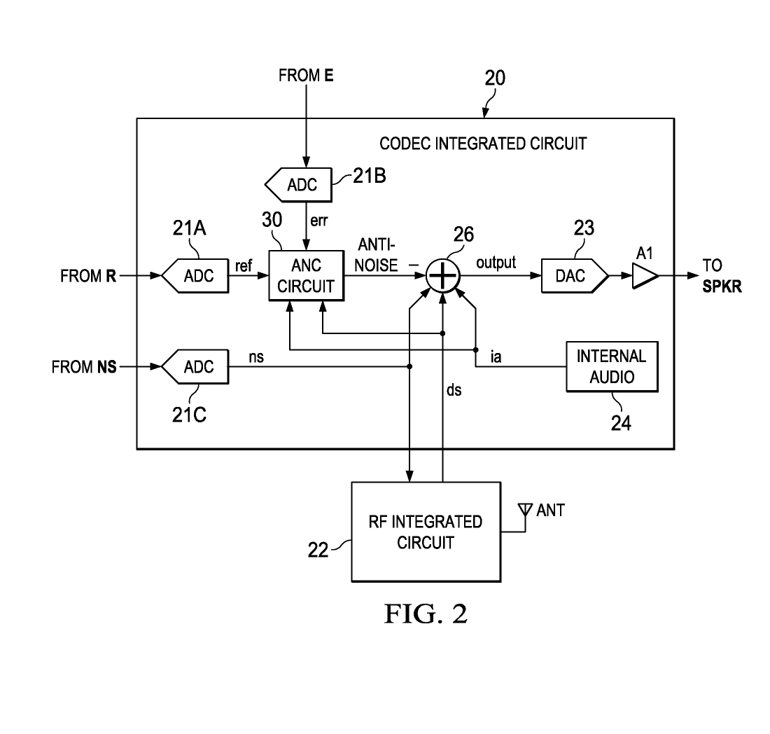

Referring now to FIG. 2, selected circuits within wireless telephone 10 are shown in a block diagram, which in other embodiments may be placed in whole or in part in other locations such as one or more headphones or earbuds. CODEC IC 20 may include an analog-to-digital converter (ADC) 21A for receiving the reference microphone signal from microphone R and generating a digital representation ref of the reference microphone signal, an ADC 21B for receiving the error microphone signal from error microphone E and generating a digital representation err of the error microphone signal, and an ADC 21C for receiving the near speech microphone signal from near speech microphone NS and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals is from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of wireless telephone 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

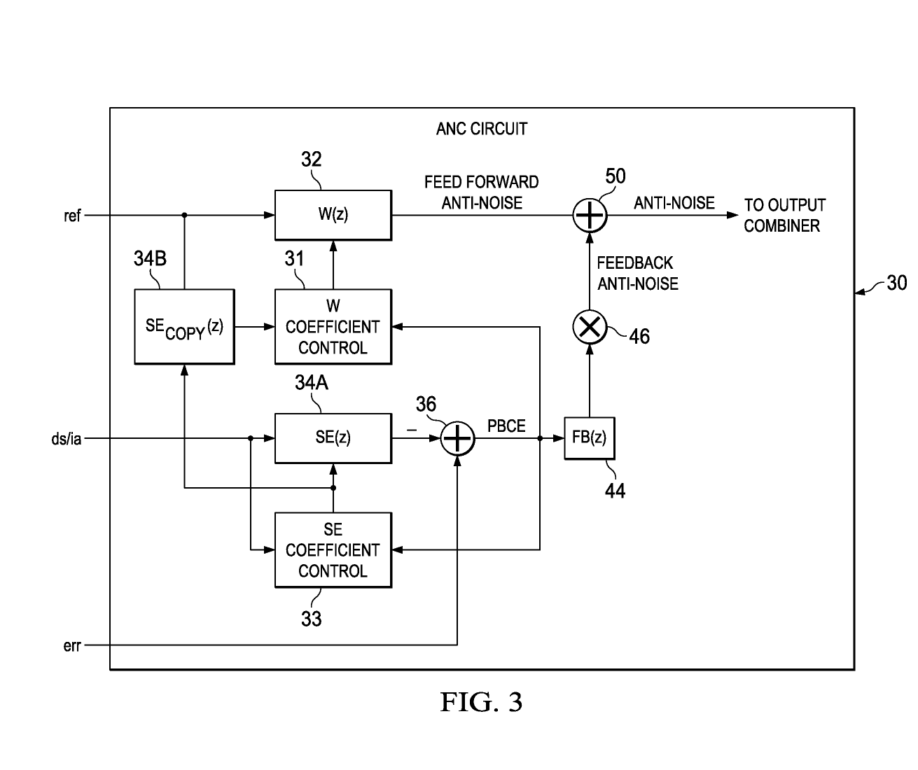

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate a feedforward anti-noise component of the anti-noise signal, which may be combined by combiner 50 with a feedback anti-noise component of the anti-noise signal (described in greater detail below) to generate an anti-noise signal which in turn may be provided to an output combiner that combines the anti-noise signal with the source audio signal to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err. By transforming reference microphone signal ref with a copy of the estimate of the response of path S(z), response SE_{COPY}(z), and minimizing the ambient audio sounds in the error microphone signal, adaptive filter 32 may adapt to the desired response of P(z)/S(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a copy. By injecting an inverted amount of downlink audio signal ds and/or internal audio signal ia, adaptive filter 32 may be prevented from adapting to the relatively large amount of downlink audio and/or internal audio signal present in error microphone signal err. However, by transforming that inverted copy of downlink audio signal ds and/or internal audio signal ia with the estimate of the response of path S(z), the downlink audio and/or internal audio that is removed from error microphone signal err should match the expected version of downlink audio signal ds and/or internal audio signal ia reproduced at error microphone signal err, because the electrical and acoustical path of S(z) is the path taken by downlink audio signal ds and/or internal audio signal ia to arrive at error microphone E. Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36 to generate a playback-corrected error, shown as PBCE in FIG. 3. SE coefficient control block 33 may correlate the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

As depicted in FIG. 3, ANC circuit 30 may also comprise feedback filter 44. Feedback filter 44 may receive the playback corrected error signal PBCE and may apply a response FB(z) to generate a feedback signal based on the playback corrected error. Also as depicted in FIG. 3, a path of the feedback anti-noise component may have a gain element 46 in series with feedback filter 44 such that the product of response FB(z) and a gain of gain element 46 is applied to playback corrected error signal PBCE in order to generate the feedback anti-noise component of the anti-noise signal. In some embodiments, the gain of gain element 46 may be programmable, and such programmable gain may be controlled by another component of CODEC IC 20 or ANC circuit 30. The feedback anti-noise component of the anti-noise signal may be combined by combiner 50 with the feedforward anti-noise component of the anti-noise signal to generate the anti-noise signal which in turn may be provided to an output combiner that combines the anti-noise signal with the source audio signal to be reproduced by the transducer, as exemplified by combiner 26 of FIG. 2.

Although feedback filter 44 and gain element 46 are shown as separate components of ANC circuit 30, in some embodiments some structure and/or function of feedback filter 44 and gain element 46 may be combined. For example, in some of such embodiments, an effective gain of feedback filter 44 may be varied via control of one or more filter coefficients of feedback filter 44.

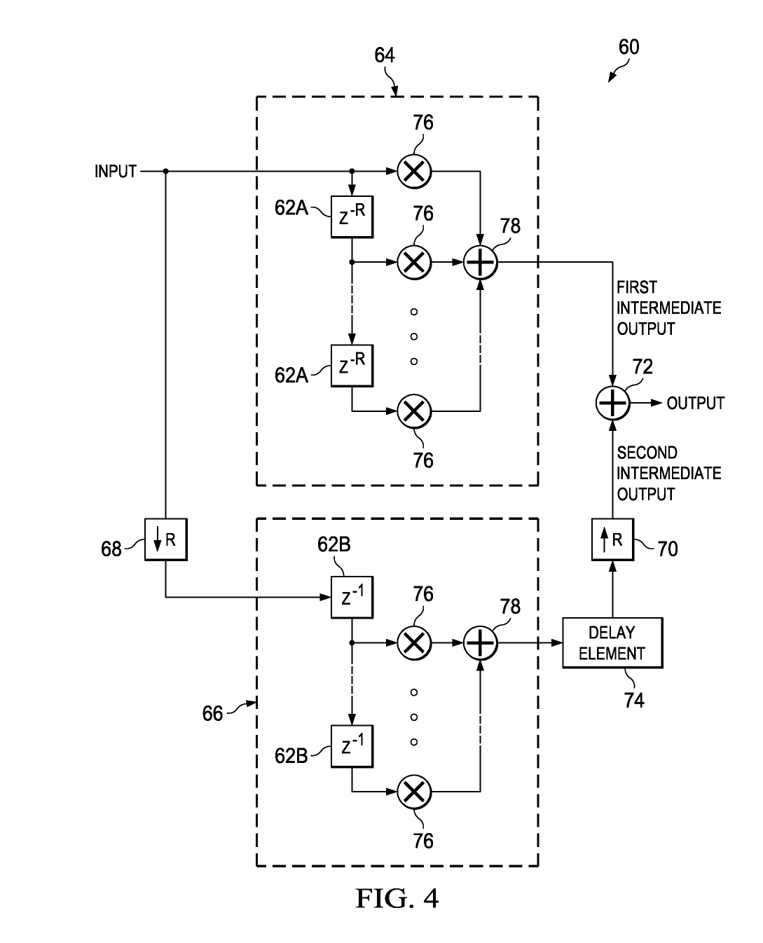

FIG. 4 is a block diagram depicting selected functional blocks within an example hybrid finite impulse response filter 60, in accordance with embodiments of the present disclosure. In some embodiments, hybrid finite impulse response filter 60 may be used to implement any of the filters (e.g., filters 32, 32A, 34B, 44) of ANC circuit 30. As shown in FIG. 4, hybrid finite impulse response filter 60 may have a plurality of delay stages 62A and 62B (which may be referred to individually as a delay stage 62 or collectively as delay stages 62) and may include a high-rate filter portion 64, a decimator 68, a low-rate filter portion 66, an interpolator 70, a summer 72, and a delay element 74.

High-rate filter portion 64 may be associated with a first portion of the plurality of delay stages 62 (e.g., those delay stages labeled 62A) and may be configured to filter an input signal (e.g., a digital signal) having a first sampling rate to generate a first intermediate output signal. The first intermediate output signal may be generated by a summer 78 that combines the input signal as delayed by the various delay stages 62A and multiplied by a respective gain of a gain element 76 associated with the delay stage 62A. Decimator 68 may comprise any suitable system for downsampling the input signal to a downsampled input signal having a second sampling rate smaller than the first sample rate. For example, in some embodiments, decimator 68 may downsample or decimate the input signal by a factor of R, such that the first sampling rate is R times that of the second sampling rate. In a specific example, R may be 32, the first sampling rate may be 1.5 MHz and the second sampling rate may be 46.875 KHz. In some embodiments, decimator 68 may comprise a low-pass filter followed by a downsampler. In such embodiments, the low-pass filter may impose a group delay. Also, in such embodiments, the low-pass filter may comprise a finite impulse response filter with linear phase, such that its delay is constant.

Low-rate filter portion 66 may be associated with a second portion of the plurality of delay stages (e.g., those delay stages labeled 62B) and configured to filter the downsampled input signal. The first intermediate output signal may be generated by a summer 78 that combines the input signal as delayed by the various delay stages 62B and multiplied by a respective gain of a gain element 76 associated with the delay stage 62B.

As shown in FIG. 4, each of the first portion of delay stages 62A may apply a response z^{-R} in the z-domain to the input signal at each delay stage 62A, while each of the second portion of delay stages 62B may apply a response z⁻¹ in the z-domain to the downsampled input signal at each delay stage 62B. Thus, the high-rate filter portion 64 performs filtering at an oversampled rate R times the rate of that which the low-rate filter portion 66 performs filtering.

Interpolator 70 may comprise any suitable system for upsampling the downsampled input signal, as filtered by the low-rate filter portion, to generate a second intermediate output signal having a sampling rate larger than the second sampling rate. In some embodiments, interpolator 70 may upsample the downsampled, filtered input signal by a factor of R, such that the second intermediate output signal has the same sample rate as the first intermediate output signal. A summer 72 may sum the first intermediate output signal and the second intermediate output signal to generate an output signal for hybrid finite impulse response filter 60.

As shown in FIG. 4, hybrid finite impulse response filter 60 may also comprise a delay element 74 associated with low-rate filter portion 66. Delay element 74 may impose a signal delay in order to perform latency matching such that an aggregate delay of delay element 74, decimator 68, and interpolator 70 is approximately equal to an aggregate delay of all of the first portion of delay stages 62A. In some embodiments, a delay element 74 may not be present, in which case an aggregate delay of decimator 68 and interpolator 70 is approximately equal to an aggregate delay of all of the first portion of delay stages 62A. Although delay element 74 is shown at a particular location within hybrid finite impulse response filter 60, in some embodiments, delay element 74 may be placed elsewhere within the signal path from the input signal to the second intermediate output signal.

In some embodiments, at least one of the respective gains of gain elements 76 may be adaptive based on at least one of a characteristic of the input signal of hybrid finite impulse response filter 60 and a characteristic of the output signal of hybrid finite impulse response filter 60. For example, when implemented as one of adaptive filters 32, 34A, or 34C of ANC circuit 30, one or more of the respective gains may be adapted by a corresponding coefficient control block (e.g., coefficient control block 31, coefficient control block 33).

Advantageously, hybrid finite impulse response filter 60 may achieve low latency while also requiring low power. High-rate filter portion 64 may be of very low-latency and thus may enable hybrid finite impulse response filter 60 to generate, for a given sample of the input signal, a corresponding sample of the output signal with low latency relative to receipt of the input signal. For example, in some embodiments, a corresponding sample of the output signal may be generated before receipt by hybrid finite impulse response filter 60 of ten subsequent samples of the input signal. In particular embodiments, for each sample of the input signal, a corresponding sample of the output signal may be generated before receipt by hybrid finite impulse response filter 60 of a subsequent sample of the input signal. In these and other embodiments, for each sample of the input signal, a corresponding sample of the output signal may be generated within 50 microseconds of receipt by hybrid finite impulse response filter 60 of the sample of the input signal. However, if finite impulse response filter 60 was implemented entirely of the high-rate filter portion, computation associated with the various delay stages 62 at the oversampled rate may require significant amounts of power and data storage. Accordingly, high-rate filter portion 64 may implement only a small number of the delay stages 62 of hybrid finite impulse response filter 60, while low-rate filter portion 66, which requires less computational power on a per-delay stage basis than high-rate filter portion 64, may implement a larger number of the delay stages 62. Latency of low-rate filter portion 66 may be greater than that of high-rate filter portion 64, but because low-rate filter portion 66 implements later stages in the delay chain of hybrid finite impulse response filter 60, such latency is tolerable.

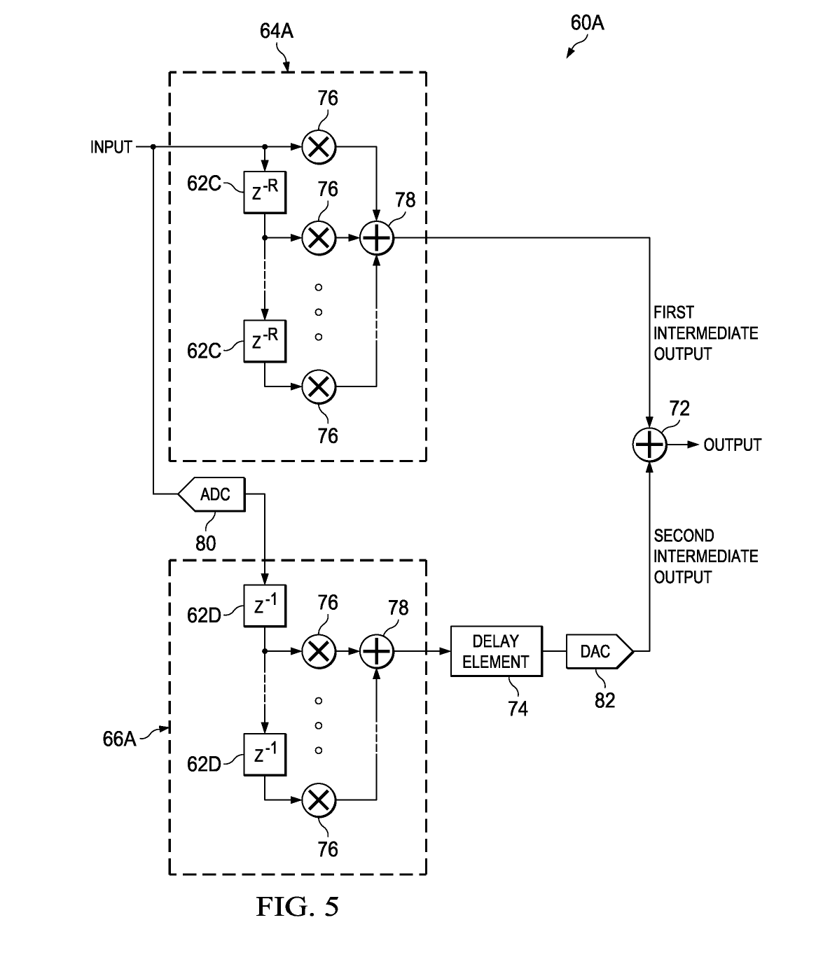

FIG. 5 is a block diagram depicting selected functional blocks within another example hybrid finite impulse response filter 60A, in accordance with embodiments of the present disclosure. In some embodiments, hybrid finite impulse response filter 60A may be used to implement any of the filters (e.g., filters 32, 32A, 34B, 44) of ANC circuit 30. In many respects, hybrid finite impulse response filter 60A may be similar or equivalent in functionality to hybrid finite impulse response filter 60 depicted in FIG. 4 and may have some or all of the same advantages (e.g., low-power, low-latency) as hybrid finite impulse response filter 60. Instead of having two digital filter portions as in hybrid finite impulse response filter 60, hybrid finite impulse response filter 60A may include an analog filter portion 64A in lieu of high-rate filter portion 64 and a digital filter portion 66A in lieu of low-rate filter portion 66. Analog filter portion 64A may be associated with a first portion of the plurality of delay stages 62C of hybrid finite impulse response filter 60A and may be configured to filter an input signal (e.g., an analog input signal) to generate a first intermediate output signal. Components of analog filter portion 64A may comprise analog components to perform filtering in the analog domain.

In lieu of decimator 68, hybrid finite impulse response filter 60A may include an analog-to-digital converter 80 configured to convert the analog input signal into a digital equivalent to be digitally filtered by digital filter portion 66A associated with a first portion of the plurality of delay stages 62D. In addition, in lieu of interpolator 70, hybrid finite impulse response filter 60A may comprise a digital-to-analog converter 82 configured to convert the signal filtered by digital filter portion 66A into a second intermediate output signal in the analog domain, to be combined by summer 72 to generate an analog output signal. As in hybrid finite impulse response filter 60 FIG. 4, hybrid finite impulse response filter 60A of FIG. 5 may include a delay element 74 may impose a signal delay in order to perform latency matching such that an aggregate delay of delay element 74, ADC 80, and DAC 82 is approximately equal to an aggregate delay of all of the first portion of delay stages 62C.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A hybrid finite impulse response filter having a plurality of delay stages, comprising:
a high-rate filter portion associated with a first portion of the plurality of delay stages and configured to filter an input signal having a first sampling rate to generate a first intermediate output signal;
a decimator for downsampling the input signal to a downsampled input signal having a second sampling rate smaller than the first sampling rate;
a low-rate filter portion associated with a second portion of the plurality of delay stages and configured to filter the downsampled input signal;
an interpolator for upsampling the downsampled input signal as filtered by the low-rate filter portion to generate a second intermediate output signal having a sampling rate larger than the second sampling rate; and
a summer for summing the first intermediate output signal and the second intermediate output signal to generate an output signal of the hybrid impulse response filter.

2. The hybrid finite impulse response filter of claim 1, wherein the second intermediate output signal has the first sampling rate.

3. The hybrid finite impulse response filter of claim 1, wherein:
each of the plurality of delay stages is associated with a respective delay; and
an aggregate delay of the decimator and the interpolator is approximately equal to an aggregate delay of all of the first portion of delay stages.

4. The hybrid finite impulse response filter of claim 1, further comprising a delay element associated with the low-rate filter portion and wherein:
each of the plurality of delay stages is associated with a respective delay; and
an aggregate delay of the delay element, the decimator, and the interpolator is approximately equal to an aggregate delay of all of the first portion of delay stages.

5. The hybrid finite impulse response filter of claim 1, wherein, for each sample of the input signal, a corresponding sample of the output signal is generated before receipt by the hybrid finite impulse response filter of a subsequent sample of the input signal.

6. The hybrid finite impulse response filter of claim 1, wherein, for each sample of the input signal, a corresponding sample of the output signal is generated before receipt by the hybrid finite impulse response filter of ten subsequent samples of the input signal.

7. The hybrid finite impulse response filter of claim 1, wherein, for each sample of the input signal, a corresponding sample of the output signal is generated within 50 microseconds of receipt by the hybrid finite impulse response filter of the sample of the input signal.

8. The hybrid finite impulse response filter of claim 1, wherein each of the plurality of delay stages has associated therewith a respective gain, and at least one of the respective gains is adaptively responsive to at least one of the input signal and the output signal.

9. The hybrid finite impulse response filter of claim 1, wherein the hybrid finite impulse response filter is configured to adapt its response to minimize an error signal.

10. The hybrid finite impulse response filter of claim 9, wherein both of the high-rate filter portion and the low-rate filter portion are configured to adapt their responses to minimize the error signal.

11. A method comprising:
filtering with a high-rate filter portion of a hybrid finite impulse response filter having a plurality of delay stages and an input signal having a first sampling rate to generate a first intermediate output signal;
downsampling the input signal to a downsampled input signal having a second sampling rate smaller than the first sampling rate;
filtering with a low-rate filter portion the downsampled input signal;
upsampling the downsampled input signal as filtered by the low-rate filter portion to generate a second intermediate output signal having a sampling rate larger than the second sampling rate; and
summing the first intermediate output signal and the second intermediate output signal to generate an output signal of the hybrid impulse response filter.

12. The method of claim 11, wherein the second intermediate output signal has the first sampling rate.

13. The method of claim 11, wherein:
each of the plurality of delay stages is associated with a respective delay;
an aggregate delay of the downsampling and the upsampling is approximately equal to an aggregate delay of all of the first portion of delay stages.

14. The method of claim 11, further comprising delaying at least one of the downsampled input signal, the downsampled input signal as filtered by the low-rate filter portion, and the downsampled input signal as filtered by the low-rate filter portion after upsampling and wherein:
each of the plurality of delay stages is associated with a respective delay;
an aggregate delay of the downsampling, the upsampling, and the delaying is approximately equal to an aggregate delay of all of the first portion of delay stages.

15. The method of claim 11, further comprising, for each sample of the input signal, generating a corresponding sample of the output signal before receipt by the hybrid finite impulse response filter of a subsequent sample of the input signal.

16. The method of claim 11, further comprising, for each sample of the input signal, generating a corresponding sample of the output signal before receipt by the hybrid finite impulse response filter of ten subsequent samples of the input signal.

17. The method of claim 11, further comprising, for each sample of the input signal, generating of the output signal within 50 microseconds of receipt by the hybrid finite impulse response filter of the sample of the input signal.

18. The method of claim 11, wherein each of the plurality of delay stages has associated therewith a respective gain, and at least one of the respective gains is adaptively responsive to at least one of the input signal and the output signal.

19. The method of claim 11, further comprising adapting a response of at least one of the high-rate filter portion and the low-rate filter to minimize an error signal.

20. The method of claim 11, further comprising adapting responses of both of the high-rate filter portion and the low-rate filter to minimize an error signal.

21. An integrated circuit for implementing at least a portion of a personal audio device, comprising:
an output for providing an output signal to a transducer including both a source audio signal for playback to a listener and an anti-noise signal for countering the effect of ambient audio sounds in an acoustic output of the transducer;
a microphone input for receiving a microphone signal; and
a processing circuit that implements:
a hybrid filter that generates the anti-noise signal to reduce the presence of the ambient audio sounds at the acoustic output of the transducer based at least on the microphone signal, the hybrid filter comprising:
a high-rate filter portion configured to filter an input signal having a first sampling rate to generate a first intermediate anti-noise signal;
a low-rate filter portion configured to filter the input signal downsampled to a second sampling rate to generate a second intermediate anti-noise signal; and
a summer to sum the intermediate anti-noise signal and the second intermediate anti-noise signal to generate the anti-noise signal.

22. The integrated circuit of claim 21, further comprising a coefficient control block that shapes the response of at least one of the high-rate filter portion and the low-rate filter portion to counter the effect of ambient audio sounds in an acoustic output of the transducer.

23. The integrated circuit of claim 21, wherein:
the microphone signal comprises a reference microphone signal indicative of the ambient audio sounds at the acoustic output of the first transducer; and
the hybrid filter comprises a feedforward filter configured to generate the anti-noise signal from the reference microphone signal.

24. The integrated circuit of claim 21, wherein:
the microphone signal comprises an error microphone signal indicative of the output of the transducer and the ambient audio sounds at the transducer; and
the hybrid filter comprises a secondary path estimate adaptive filter for modeling an electro-acoustic path of the first source audio signal through the transducer and having a response that generates a secondary path estimate signal.

25. A hybrid finite impulse response filter having a plurality of delay stages, comprising:
an analog filter portion associated with a first portion of the plurality of delay stages and configured to filter an input signal to generate a first intermediate output signal;
a digital filter portion associated with a second portion of the plurality of delay stages and configured to filter the input signal to generate a second intermediate output signal; and
a summer for summing the first intermediate output signal and the second intermediate output signal to generate an output signal of the hybrid impulse response filter.

26. The hybrid finite impulse response filter of claim 25, wherein:
each of the plurality of delay stages is associated with a respective delay; and
each of the respective delays of the first portion of the plurality of delay stages are lower than each of the respective delays of the second portion of the plurality of delay stages.

27. The hybrid finite impulse response filter of claim 25, wherein, for each sample of the input signal, a corresponding sample of the output signal is generated before receipt by the hybrid finite impulse response filter of a subsequent sample of the input signal.

28. The hybrid finite impulse response filter of claim 25, wherein, for each sample of the input signal, a corresponding sample of the output signal is generated before receipt by the hybrid finite impulse response filter of ten subsequent samples of the input signal.

29. The hybrid finite impulse response filter of claim 25, wherein, for each sample of the input signal, a corresponding sample of the output signal is generated within 50 microseconds of receipt by the hybrid finite impulse response filter of the sample.

30. The hybrid finite impulse response filter of claim 25, wherein each of the plurality of delay stages has associated therewith a respective gain, and at least one of the respective gains is adaptively responsive to at least one of the input signal and the output signal.

31. A method comprising:
filtering with an analog filter portion associated with a first portion of a plurality of delay stages of a hybrid finite impulse response filter an input signal to generate a first intermediate output signal;
filtering with a digital filter portion associated with a second portion of the plurality of delay stages the input signal to generate a second intermediate output signal; and
summing the first intermediate output signal and the second intermediate output signal to generate an output signal of the hybrid impulse response filter.

32. The method of claim 31, wherein:
each of the plurality of delay stages is associated with a respective delay; and
each of the respective delays of the first portion of the plurality of delay stages are lower than each of the respective delays of the second portion of the plurality of delay stages.

33. The method of claim 31, further comprising, for each sample of the input signal, generating a corresponding sample of the output signal before receipt by the hybrid finite impulse response filter of a subsequent sample of the input signal.

34. The method of claim 31, further comprising, for each sample of the input signal, generating a corresponding sample of the output signal before receipt by the hybrid finite impulse response filter of ten subsequent samples of the input signal.

35. The method of claim 31, further comprising, for each sample of the input signal, generating of the output signal within 50 microseconds of receipt by the hybrid finite impulse response filter of the sample.

36. The method of claim 31, wherein each of the plurality of delay stages has associated therewith a respective gain, and at least one of the respective gains is adaptively responsive to at least one of the input signal and the output signal.
